(19) United States
(12) Patent Application Publication
(10) Pub. No.: US 2003/0011774 A1
(43) Pub. Date: Jan. 16, 2003

(54) Methods and systems for monitoring process fluids

(76) Inventors: Gerald N. DiBello, West Chester, PA (US); Christopher L. Carter, Downingtown, PA (US); Karrie L. Bowen, Apple Valley, MN (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/163,441

(22) Filed: Jun. 4, 2002

Related U.S. Application Data
(60) Provisional application No. 60/295,919, filed on Jun. 5, 2001.

(51) Int. Cl. B08B 3/00; G01N 21/25

(52) U.S. Cl. 356/436; 134/18; 134/41; 134/57 R; 134/902; 356/409

(57) ABSTRACT

A method for treating an electronic component wherein the value of an optical property associated with a process fluid is measured and compared with a threshold value of an optical property. This comparison is used to determine what modification, if needed, should be made to the process fluid to restore it to its threshold value. Also disclosed is a system for treating electronic components with a process fluid.

### CROSS REFERENCE TO RELATED APPLICATIONS

The present application claims the benefit of priority under 35 U.S.C. §119(e) from provisional U.S. Application Serial No. 60/295,919, filed on Jun. 5, 2001, which is incorporated herein by reference in its entirety.

### FIELD OF THE INVENTION

The present invention relates to methods and systems for wet processing semiconductor substrates. More particularly, the present invention provides methods and systems for determining the optical properties of wet processing fluids and thereby controlling the processing of electrical components.

### BACKGROUND OF THE INVENTION

Wet processing of electronic components, such as semiconductor wafers, flat panels, and other electronic component precursors is used extensively during the manufacture of integrated circuits. Semiconductor fabrication is described generally, for example, in P. Gise et al., Semiconductor and Integrated Circuit Fabrication Techniques (Reston Publishing Co. Reston, Va. 1979), the disclosure of which is herein incorporated by reference in its entirety.

Preferably, wet processing is carried out to prepare the electronic components for processing steps such as diffusion, ion implantation, epitaxial growth, chemical vapor deposition, hemispherical silicon grain growth, or combinations thereof. During wet processing, the electronic components are contacted with a series of processing solutions. The processing solutions may be used, for example, to etch, remove photoresist, clean, grow an oxide layer, or rinse the electronic components. See, e.g., U.S. Pat. Nos. 4,577,650; 4,740,249; 4,738,272; 4,856,544; 4,633,893; 4,778,532; 4,917,123; and EP 0 233 184, assigned to a common assignee, and Burkman et al., Wet Chemical Processes-Aqueous Cleaning Processes, pg 111-151 in Handbook of Semiconductor Wafer Cleaning Technology (edited by Werner Kern, Published by Noyes Publication Parkridge, N.J. 1993), the disclosures of which are herein incorporated by reference in their entirety.

There are various types of systems available for wet processing. For example, the electronic components may be processed in a single vessel system closed to the environment (such as an Omni system employing Full-Flow™ technology supplied by Mattson Technologies, Inc.), a single vessel system open to the environment, or a multiple open bath system (e.g., wet bench) having a plurality of baths open to the atmosphere.

Following processing, the electronic components are typically dried. Drying of the semiconductor substrates can be done using various methods, with the goal being to ensure that there is no contamination created during the drying process. Methods of drying include evaporation, centrifugal force in a spin-rinser-dryer, steam or chemical drying of wafers, including the methods and apparatus disclosed in, for example, U.S. Pat. No. 4,911,761.

An important consideration for an effective wet processing method is that the electronic component produced by the process be ultraclean (i.e., with minimum particle contamination and minimum chemical residue). An ultraclean electronic component is preferably free of particles, metallic contaminants, organic contaminants, and native oxides; has a smooth surface; and has a hydrogen-terminated surface. Although wet processing methods have been developed to provide relatively clean electronic components, there is always a need for improvement because of the intricacies associated with technological advances in the semiconductor industry. One of the most challenging problems of attaining ultraclean products is the removal of photoresist.

It is well known to use process fluids, such as sulfuric acid or sulfuric acid mixtures, i.e., sulfuric acid combined with other fluids such as oxidizing agents like ozone gas or hydrogen peroxide, in wet processing systems to remove organics, post-ashing or post-plasma processing residues from the wafer. A further purpose of these sulfuric acid or sulfuric acid mixtures is to remove photoresist from wafers, thereby eliminating the ashing or plasma process steps. The removed photoresist and/or post-processing residues may be both dissolved and digested or oxidized within the acid. At times, these residues impart a perceptible color change within the sulfuric acid or sulfuric acid mixture. After continuous processing cycles, the appearance of the acid may change in color and/or opacity due to a high residue concentration or water dilution level.

One common phenomena that may occur after exposing electronic components, such as silicon wafers or substrates, to sulfuric acid or sulfuric acid mixture is the development of a haze growth on the surface of the component. This ‘haze’ growth may take approximately 24 hours within a closed transport box to manifest. There are presently no available means to determine if or when the haze growth will occur. It is believed that haze onset or growth rate may be controlled by the employing a particular water rinse methodology and/or modifying temperature after exposure to the sulfuric acid or sulfuric acid mixtures. In some cases, excessive rinsing with deionized water (“DIW”) at elevated temperatures such as 65° C. and 25 gallons per minute (“gpm”) for 15 minutes may be employed to eliminate or reduce haze growth. In other cases, megasonic energy may be employed, such as a 10 minute cycle of megasonic energy applied at temperatures of 90° C., to remove the chemical, metallic, or particle species that may lead to haze growth.

The onset of and growth rate of haze may be attributable to the loss of the oxidizing and cleaning efficiency of the sulfuric acid and sulfuric acid mixtures. If it could be determined when haze growth would result from processing with the sulfuric acid and sulfuric acid mixture, the rinse rate and rinse temperature could be minimized, thereby imparting a more cost effective and environmentally friendly solution. Otherwise, excessive amounts of expensively heated water, DIW, and/or expensive megasonic rinses may be needed to ensure haze growth-free processing.

In addition to arresting the growth and development of haze on the electronic components, it would be useful to determine when the cleaning potential of the sulfuric acid and sulfuric acid mixtures is low. For example, if large concentrations of inert material, contaminates, and/or undigested photoresist are present in the process fluid, the fluid may have difficulty in performing its primary purpose of cleaning organics, post ash, and/or post plasma residue from the components. Current means of determining the useful life of the sulfuric acid or sulfuric acid mixtures include tracking the number of process cycles that the process fluid has been exposed to the electronic components and/or had additional amounts of chemicals such as oxidizers added to reconstitute the process fluid. The process fluid may be discarded after a certain number of process cycles and/or cycles of reconstitution. It would be useful to develop a method or system whereby one can determine the point at which the sulfuric acid or sulfuric acid mixture is suitable for the addition of a chemical or needs to be discarded.

Similarly, ozonated de-ionized water (“DO3”) may be used in some processes as a substitute for sulfuric acid and sulfuric acid mixtures. The effectiveness of this process fluid solution may be compromised by the increase of contaminants and solutes within the fluid. After a certain number of exposures to the electronic components, the particle cleaning ability or the organic stripping property may no longer be effective. It would be useful to develop a method to monitor the process fluid to determine at what point to reconstitute the fluid by adding a chemical such as, for example, an oxidizing agent or when to replace the fluid entirely.

Another known process fluid is phosphoric acid or phosphoric acid mixtures such as phosphoric acid mixed with small amounts of hydrochloric acid, nitric acid, and water. Typical concentrations of hydrochloric acid and nitric acid may range from about 0.2% to about 5%. One purpose of the phosphoric acid or phosphoric acid mixtures is to etch silicon nitride from the surface of the electronic component. These process fluids may be used at high temperatures, generally greater than 150° C., with a constant, slow flow of water to ensure boiling. When used in this manner, the phosphoric acid or phosphoric acid mixture provides a high selectivity of silicon nitride etch to silicon oxide etch rate. With repeated process cycles, the phosphoric acid and phosphoric acid mixtures become saturated with silicon, silicon nitride, and silicon dioxide. Eventually, the phosphoric acid or phosphoric acid mixture process fluids turn opaque with the silicon, silicon nitride, and silicon dioxide solute. When the process fluid turns opaque, the particle addition on the surface of the electronic components increases. To remedy this problem, extensive rinsing with DIW heated to temperatures ranging from about 45° C. to about 65° C. may be required to produce a surface free from chemicals and particles. These rinses are sometimes combined with megasonic energy. It would be useful to develop a method and/or system to determine the point at which the process fluid would impart particles on the surface. This point could be used to signal the initiation of a different rinse strategy or the need to replace the process fluid.

Yet other known process fluids are dilute hydrofluoric acid mixtures (“HF”) or buffered hydrofluoric acid (“BHF”) mixtures. Some of the purposes of these fluids are to etch various films with the proper etch rate, maintain a selectivity to different surface films, maintain substrate surface counts, and particularly for BHF, improve the wettability to small surface geometries. These process fluids dissolve silicon dioxides, doped silicon, as well as other deposited and grown films. The film, along with any intentional doping and unintentional contamination contained on or within the film, is dissolved or absorbed by the process fluid. For these process fluids, increases in contamination and solute concentration diminish the useful life of the etching bath. Particle counts and resultant substrate surface contamination eventually increase with increasing solute concentrations. It would be desirable to determine the endpoint of the useful life of these process fluids to reduce the product yield loss or reduce the frequency of fluid replacement.

Further examples of process fluids may comprise proprietary solvent mixtures. These solvent mixtures are typically used, for instance, for cleaning and stripping applications where the substrates contain metal and an acidic mixture cannot be used. These process fluids may be used to clean organics and post-ashing or post-plasma processing residues from the substrate when metal layers are present. Further, these process fluids may be used directly to remove photoresist from wafers, thus bypassing the ashing or plasma process steps. The photoresist and post-processing residue may be dissolved by the solvating action of these fluids. These residues can impart a color change within the fluids. The increased amount of contaminants within the fluid eventually comprises the efficacy of the organic stripping capability. Moreover, the increased amount of contaminants also adversely affects the substrate's particle counts. As the process fluid reaches the end of its useful life, a second solvent bath may be used to expose the substrates to a ‘clean’ solvent and to remove the first solvent containing high levels of solute and contaminants from the substrate surface. It would be desirable to determine the endpoint of the useful life of these process fluids in order to reduce the product yield loss or eliminate the need for additional processing steps.

Thus, there is a need in the art for a simple and efficient method to determine and/or extend the useful life of a process fluid, while at the same time providing an environmentally safe and economical method.

The present invention meets these as well as other needs. For example, the present invention provides methods and systems for optimizing the processing efficacy, such as cleaning efficiency or etch rate, of various process fluids. One beneficial result of the present invention is the reduction or elimination of process steps such as additional rinses and solvent baths. A further beneficial result of the present invention is the reduction of particle counts on the surface of the electronic component. Yet an additional beneficial result would be the reduction or elimination of haze growth on the surface of the electronic component.

### SUMMARY OF THE INVENTION

The present invention provides, inter alia, wet processing methods, and systems for the manufacture of electronic components, including electronic component precursors such as semiconductor wafers used in integrated circuits. More specifically, this invention relates to methods and systems that are used to determine the endpoint of efficacy and/or extend the useful life of process fluids that are used in wet processing techniques. The methods and systems of the present invention rely upon optical property value measurements of the process fluids to determine when the fluid has reached the end of its useful life or can be reconstituted. Moreover, the methods and systems enhance process control and product yield because the electronic components are contacted with process fluids having a controlled range of optical property values.

In one of its aspects, the present invention relates to a method for monitoring a processing fluid. This method comprises measuring a first value of an optical property associated with a process fluid and comparing this first value with a threshold value of an optical property. The comparison between the first value and the threshold value is used to determine what modification, if any is needed, to restore the process fluid to its threshold value. In some preferred aspects, the comparison is used to determine what quantity of chemical, if any, to add to the process fluid. A further embodiment of the present invention may comprise the additional step of adding a chemical to the process fluid in the quantity determined.

In a further aspect, the present invention relates to a method of processing an electronic component. This method comprises the steps of measuring the initial value of an optical property associated with a process fluid; exposing the process fluid to a batch of one or more electronic components within a vessel; measuring the subsequent values of optical property within a process fluid in periodic intervals; comparing the initial value of the optical property with the measured values of optical property; and modifying the process fluid based upon the comparison the quantity of a chemical, if needed, to restore the process fluid to the initial optical property value. In some embodiments, this comparison is also used to determine the time and temperature in which to react the chemical within the process fluid.

In yet a further aspect, the present invention relates to a system for treating an electrical component. This system comprises a process chamber that contains one or more electrical components; a process fluid reservoir that is in fluid communication with the process chamber; an optical measurement system; a chemical reservoir that is in fluid communication with the process fluid reservoir; and a processor that is in electrical communication with the optical measurement system and the chemical reservoir. The processor compares the first value of optical property with a threshold optical value. Based upon this comparison, the processor may release a quantity of chemical, if needed, from the chemical reservoir to the process fluid reservoir to restore the value of optical property to the threshold value.

### BRIEF DESCRIPTION OF THE DRAWINGS

The numerous objects and advantages of the present invention may be better understood by those skilled in the art by reference to the accompanying detailed description and the following drawings, in which:

FIG. 1 provides a flow diagram of the process steps for one embodiment of the method of the present invention.

FIG. 2 shows an embodiment of a system of the present invention for measuring the optical properties of the wet processing fluids.

### DETAILED DESCRIPTION OF THE INVENTION

The present invention provides apparatus and methods for wet processing electronic components using a process fluid. The methods and systems of the present invention rely upon optical property value measurements of the process fluids. For example, during wet processing, the process fluids may be used to remove organic materials such as photoresists (ashed or unashed), plasticizers, surfactants, fluorocarbon polymers, organics from human contact, or combinations thereof from the surface of the component. These organic materials may cause the process fluid to undergo a color change and/or darken or turn opaque. The methods and systems of the present invention measure the optical property values of these process fluids and compare these values against a threshold value to determine when the fluid has reached the end of its useful life or may be reconstituted through the addition of a chemical. If the process fluid is reconstituted, the optical property values of the reconstituted fluid are measured and compared against a threshold value prior to further exposure of the process fluid to the electronic components. In this regard, the electronic components are exposed to process fluid of a certain threshold value. This ensures process uniformity and improves product yield.

The terminology “electronic components,” as used herein, includes for example electronic component precursors such as semiconductor wafers, flat panels, and other components used in the manufacture of electronic components (i.e., integrated circuits); CD ROM disks; hard drive memory disks; or multichip modules.

The terminology “wet processing” or “wet process” as used herein means the electronic components are contacted with one or more liquids (hereinafter referred to as “process liquids” or “process solutions”) to process the electronic components in a desired manner. For example, it may be desired to treat the electronic components to clean, etch, or remove photoresist from the surfaces of the electronic components. It may also be desired to rinse the electronic components between such treatment steps. As used herein, “chemical treatment step” or “wet processing step” refers to contacting the electronic components with a reactive chemical process fluid or rinsing fluid, respectively.

The terminology “process chamber” and “reaction chamber,” as used herein, refer to vessels (enclosed or open to the atmosphere), baths, wet benches and other reservoirs suitable for wet processing electronic components. The terminology “single vessel,” refers to any wet processing system in which the electronic components are maintained in one processing chamber during the entire wet processing sequence.

Wet processing may also include steps where the electronic components are contacted with other fluids, such as a gas, a vapor, a liquid mixed with a vapor or gas, or combinations thereof. As used herein, the term “process fluid” includes liquids, gases, liquids in their vapor phases, or combinations thereof. The terminology “vapor” as used herein is meant to include partially vaporized liquid, saturated vapor, unsaturated vapor, supersaturated vapor, carrier gases, or combinations thereof There are various process fluids used during wet processing. Generally, the most common types of process fluids used during wet processing are reactive chemical process fluids or liquids, and rinsing fluids or liquids. The terminology “reactive chemical process fluid” or “reactive chemical process liquid” as used herein, is any liquid or fluid that reacts in some desired manner with the surfaces of the electronic components to alter the surface composition of the electronic component. For example, the reactive chemical process liquid or fluid may have activity in removing contamination adhered or chemically bound to the surfaces of the electronic components, such as particulate, metallic, photoresist, or organic materials; activity in etching the surfaces of the electronic component; or activity in growing an oxide layer on the surface of the electronic component. As used herein, “rinsing liquid” or “rinsing fluid” refers to DI water or some other liquid or fluid that removes from the electronic components and/or processing chamber residual reactive chemical process fluids, reaction by-products, and/or particles or other contaminants freed or loosened by the chemical treatment step. The rinsing liquids or fluids may also be used to prevent redeposition of loosened particles or contaminants onto the electronic components or processing chamber. Examples of reactive chemical process fluids and rinsing fluids useful in the methods of the present invention are described in more detail hereinafter.

There are various ways in which the electronic components can be wet processed in accordance with the present invention. For example, wet processing can be carried out using sonic energy (such as in the megasonic energy range) during the contacting of the electronic components with the ozonated process fluid to enhance cleaning. Such methods may also include wet processing techniques disclosed in for example U.S. Pat. Nos. 5,383,484; 6,132,522; and 6,245,158; U.S. patent application Ser. No. 09/209,101, filed Dec. 10, 1998; and Ser. No. 09/253,157, filed Feb. 19, 1999; and U.S. Provisional Patent Application Ser. 60/111,350 filed Dec. 8, 1998, the disclosures of which are all hereby incorporated by reference in their entireties.

In a typical wet processing system, the electronic components may be contacted with any number of other reactive chemical process fluids (e.g., gas, liquid, vapor or any combination thereof) to achieve the desired result. The endpoint of useful life of these process fluids may be determined using the methods and systems of the present invention. For example, the electronic components may be contacted with reactive chemical process fluids used to etch, grow an oxide layer, to remove photoresist, to enhance cleaning, or combinations thereof. The electronic components may also be rinsed with a rinsing fluid at any time during the wet processing method. Preferably, the reactive chemical process fluids and rinsing fluids are liquids. Such processing steps are optionally performed: (1) prior to exposing the component to the heated solvent; (2) after exposing the component to the heated solvent but prior to exposing the component to the ozonated process fluid; (3ashing) after exposing the component to the ozonated process fluid but prior to exposing the component to the optional drying process fluid; and/or (4) after exposing the component to the optional drying process fluid. Suitable methods and systems of injecting processing fluids or other chemicals into the process chamber of the vessel module are described in, for example, U.S. Pat. Nos. 4,778,532; 4,917,123; 4,795,497; and 4,899,767, which are hereby incorporated by reference in their entireties.

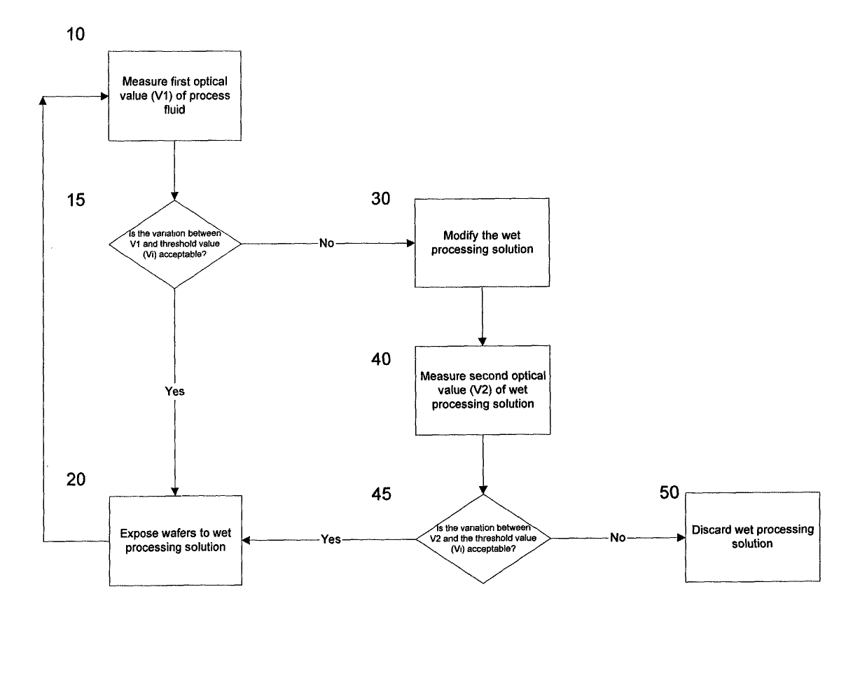

In particular, the present invention relates to methods for providing a process fluid having a certain, threshold optical property value. FIG. 1 provides a flow diagram of one embodiment of the method of the present invention. As mentioned previously, process fluids in a wet processing step change color or darken after exposure to the electronic components. In step 10, a first value of an optical property, referred to as VI in the figure, is obtained after one or multiple processing cycles. The value of optical property generally relates to the amount of organic or other contaminants that are present within 110 the process fluid. For example, if the value of optical property measured is color, applying Beer's Law, the change in absorbance (transmission) may be proportional to the concentration of a known fluid compared to the concentration of a sample fluid. This value of optical property may be obtained by a variety of devices, including but not limited to, calorimeters, spectrophotometers (if monochromatic light or a narrow band of radiation is used), photometers, IR photograph, refraction layers, digital imaging, ultraviolet light detectors or meters, or turbidity meters. Examples of colorimeters that may be used for measuring the value include, but are not limited to, calorimeters manufactured by Minolta U.S.A. of Rahway, N.J., Continental Hydrodyne Systems, Inc. of Covington, Ky., Hach Company, of Loveland, Co, or The Electron Machine Corporation of Umatilla, Fla. Examples of spectrophotomers that may be used for measuring the value include, but are not limited to, spectrophotometers manufactured by Minolta U.S.A. of Rahway, N.J., Spectral Instruments of Tuscon, Ariz., or Labomed, Inc. of Los Angeles, Calif. Examples of turbidity meters that may be used for measuring the value include, but are not limited to, turbidity meters manufactured by Honeywell of Tuscon, Ariz. An example of a photometer may be manufactured by J. M. Canty Inc. of Buffalo, N.Y. It is anticipated that one optical value, or an iterative series of optical values, may be measured.

Once the initial value of optical property is obtained, in step 15, the initial value is compared against a threshold optical value. As used herein, the term “threshold optical value” or “threshold value”, referred to in FIG. 1 as Vi, can denote one value or a range of values. The threshold value may be viewed as the optimal value for efficacy, such as, for example, cleaning efficiency or etch rate, of the process fluid. In other words, the threshold value may be the value of the optical property associated with a freshly prepared batch of process fluid. In step 15, the first optical value is compared against the threshold optical value. In some instances, the variation between these values is then determined. By “variation,” as used herein, it is meant the difference between the threshold value and measured value of a variable divided by the threshold value of the variable. In other embodiments of the present invention wherein the threshold value is a range, the initial value may be directly compared against the threshold value to see if the initial value falls within the range. In yet other embodiments, the initial value is compared against the threshold value to determine if the initial value is substantially equal to the threshold value. In preferred embodiments, the process fluid will not be exposed to the batch of semiconductor wafers unless the measured optical property is at the threshold value or within the threshold value range. Referring to FIG. 1, if in step 15 the measured value of the optical property is at the threshold value or within the threshold value range, the process fluid may then be exposed to the batch of semiconductors in accordance with step 20.

The comparison between the initial value and threshold value may be used to determine what modification needs to be made, if any, to restore the process fluid to the threshold value or range of values. Examples of such modifications may include, for example, the addition of a chemical or gas, additional processing, filtering, clarifying, ozone bubbling, or a variety of other any of a variety of methods to reconstitute the process fluid. In preferred embodiments, the comparison between the initial and threshold values is used to determine what quantity, if any, of chemical needs to be added to reconstitute the process fluid. As used herein, “reconstituted process fluid” relates to process fluid that has been modified to restore the optical property to the threshold value. In step 15, if the difference or variation between the first optical value and the threshold value is minimal, or if the variation falls within the threshold value range, the process fluid may be used for further processing. In this situation, no modification needs to be made to the process fluid to reconstitute. In step 20, the process fluid may be exposed to one or more electronic components such as a batch of silicon wafers. The cycle may then be repeated, or returned to step 10, after each process cycle wherein the process fluid has been exposed to the batch of wafers.

If, however, the difference or variation between the initial value and the threshold value is great, or the first optical value falls outside the threshold value range, in step 30, the process fluid is modified to restore it to the threshold value. In embodiments where the process is modified by adding additional chemicals to the process fluid, the quantity of chemical needed to reconstitute the process fluid may be directly related to the difference or variation of the initial value and the threshold value. In these embodiments, the added chemical may be an oxidizing agent such as gaseous or liquid ozone (“O₃”) or liquid hydrogen peroxide (“H₂O₂”) or an additional chemical such as hydrochloric acid (“HCl”) or nitric acid (“HNO₃”). In embodiments where an additional quantity of ozone is added to an acid-based process fluid, the quantity of ozone to be added (which is the volume of ozone measured in milliliters of gas) may be calculated as follows:

$$Quantity ( {O}_{3} ) = 1000 \times \frac{( {A}_{2} - {A}_{o} ) ( V )}{( C )}$$

wherein A₂ is the measured optical measurement that relates to liquid concentration in mg/l; Aₒ is the threshold optical measurement that relates to the threshold or desired liquid concentration; V is the volume of acid that is present in the process fluid expressed in liters; and C is the concentration of ozone in the added gas expressed in g/m³. In embodiments where an addition acid-based chemical is added to replenish a process fluid with another stock, bulk chemical, the quantity of acid to be added (which is the mass of replenishing acid to be added) may be calculated as follows:

$$Quantity ( mass of replenishing acid to add ) = \frac{( {A}_{2} - {A}_{o} ) ( M )}{( C - {A}_{o} )}$$

wherein A₂ is the measured optical measurement that relates to liquid concentration in mass fraction; Aₒ is the threshold optical measurement that relates to the threshold or desired mass fraction; M is the mass of acid or solution that is present in the process fluid expressed in grams; and C is the concentration of the added acid expressed in mass fraction. The preceding equation may also be calculated in volumetric units as follows:

$$Quantity ( volume of replenishing acid to add ) = \frac{( {A}_{2} - {A}_{o} ) ( V )}{( C - {A}_{o} )}$$

wherein A₂ is the measured optical measurement that relates to liquid concentration in mg/l; Aₒ is the threshold optical measurement that relates to the threshold or desired concentration in mg/l; V is the volume of acid or solution that is present in the process fluid expressed in liters; and C is the concentration of the added acid expressed in mg/l.

After the process fluid is modified, in step 40, a subsequent value of an optical property associated with the reconstituted process fluid, referred to in FIG. 1 as V2, is obtained. In step 45, this subsequent value is compared against the threshold value to determine the difference or variation between the subsequent and the threshold values. In some embodiments, the initial value is compared against the threshold value to determine if the initial value is substantially equal to the threshold value. Alternatively, if the threshold value defines a range, the subsequent value may be compared against this threshold optical value to see if the subsequent value falls within this range. Although it is not shown in FIG. 1, in some embodiments, steps 30 and 40 may be repeated until the difference or variation between the subsequent and threshold values is acceptable or the subsequent optical value falls within the threshold value range. If, however, the modification made in step 30 fails to restore the subsequent value to the threshold value, the process fluid may be discarded (see step 50) and replaced with a fresh batch of process fluid.

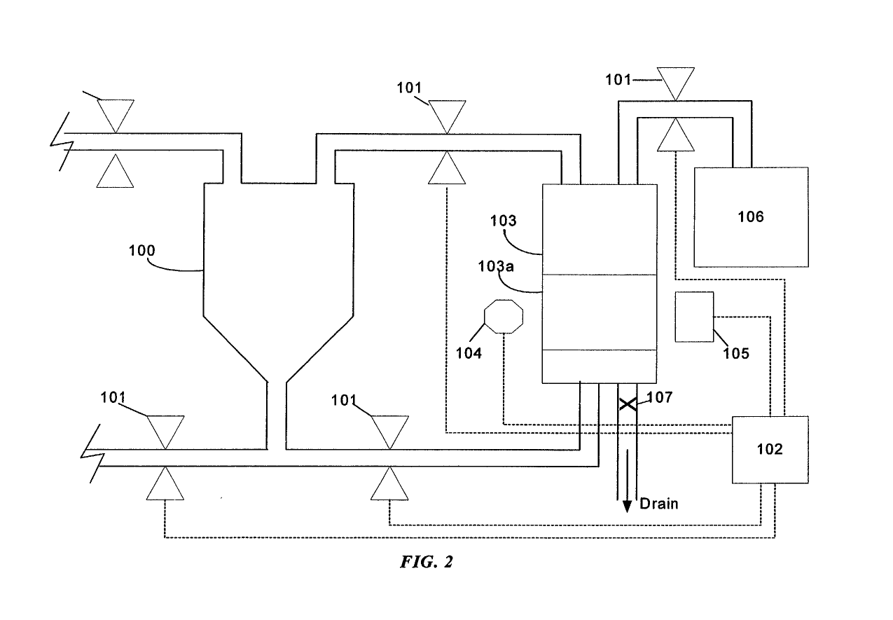

FIG. 2 illustrates an embodiment of the system of the present invention. As provided in FIG. 2, the present invention may be carried out using a process chamber 100 comprising generally any of the known wet processing systems including, for example, multiple bath systems (e.g., wet bench) and single processing chamber systems (open or closable to the environment). See, e.g., Chapter 1: Overview and Evolution of Semiconductor Wafer Contamination and Cleaning Technology by Werner Kern and Chapter 3: Aqueous Cleaning Processes by Don C. Burkman, Donald Deal, Donald C. Grant, and Charlie A. Peterson in Handbook of Semiconductor Wafer Cleaning Technology (edited by Werner Kern, Published by Noyes Publication Parkridge, N.J. 1993), and Wet Etch Cleaning by Hiroyuki Horiki and Takao Nakazawa in Ultraclean Technology Handbook, Volume 1, (edited by Tadahiro Ohmi published by Marcel Dekker), the disclosures of which are herein incorporated by reference in their entirety.

In one embodiment of the invention, the electronic components are housed in a single processing chamber system depicted in FIG. 2 as 100. Preferably, single processing chamber systems such as those disclosed in U.S. Pat. Nos. 4,778,532, 4,917,123, 4,911,761, 4,795,497,4,899,767, 4,984,597,4,633,893, 4,917,123,4,738,272, 4,577,650, 5,571,337 and 5,569,330, the disclosures of which are herein incorporated by reference in their entirety, are used. Preferred commercially available single processing chamber systems are Omni and Hybrid vessels such as those manufactured by Mattson Technology, Inc., and FL820L manufactured by Dainippon Screen.

The enclosable single wet processing chamber system shown in FIG. 2 is also preferably capable of receiving different process fluids in various sequences. A preferred method of delivering process fluids to the processing chamber is by direct displacement of one fluid with another. The Omni wet processing system employing Full-Flow™ technology manufactured by Mattson Technology, Inc. is an example of a system capable of delivering fluids by direct displacement. Such systems are preferred because they result in a more uniform treatment of the electronic components. Additionally, often the chemicals utilized in the chemical treatment of electronic components are quite dangerous in that they may be strong acids, alkalis, or volatile solvents. Enclosable single processing chambers minimize the hazards associated with such process fluids by avoiding atmospheric contamination and personnel exposure to the chemicals, and by making handling of the chemicals safer.

The single vessel wet processing system also preferably includes metering devices such as one or more control valves (shown in FIG. 2 as valves 101) and/or one or more pumps (not shown in FIG. 2) for transporting chemical reagents from the storage tank area, such as the process fluid reservoir 103 and in FIG. 2, to the reaction chamber. A processing control system, such as a personal computer shown in FIG. 2 as processor 102, is also typically used as a means to monitor processing conditions (e.g., flow rates, mix rates, exposure times, and temperature). For example, the processing control system can be used to program the flow rates of chemical reagents and deionized water so that the appropriate concentration of chemical reagent(s) will be present in the reactive chemical process fluid. In FIG. 2, the processing control system is depicted as being in electrical communication (see dotted lines in FIG. 2) with the various control valves within the system.

Preferably the wet processing system may also include storage tanks for chemical reagents, such as ammonium hydroxide (NH₄OH) or hydrofluoric acid (HF); and a system for delivering deionized water used for rinsing the electronic components and diluting the chemical reagents. The chemical reagents are preferably stored in their concentrated form, which is: hydrogen peroxide (H₂O₂) (31%), NH₄OH (28%), HCl (37%), HF (49%), sulfuric acid (H₂SO₄) (98%), and phosphoric acid (H₃PO₄) (79-87%)(percentages represent weight percentages in aqueous solutions.

In the system depicted in FIG. 2, the process fluid is housed within a storage tank referred to as process fluid reservoir 103. The storage tanks are preferably arranged so that they are in fluid communication with process chamber 100 where the electronic components are treated. Process fluid reservoir 103 is also in fluid communication with a chemical reservoir 106 to supply process fluid reservoir 103 with additional chemicals if needed to reconstitute the process fluid.

In a preferred embodiment of the present invention using a single, enclosable processing chamber, one or more electronic components are placed in a single processing chamber 100 and closed to the environment. The electronic components may optionally be contacted with one or more process fluids for pretreatment. After the electronic components have been exposed to the process fluid, the process fluid is returned to the process fluid reservoir 103. An optical value of the process fluid is obtained via an optical measurement system. In FIG. 2, the optical measurement system is comprised of a light source or photo imager 104 and light detector 105 that may measure, for example, the transmission and/or absorbance of light through a window 103a within the process fluid reservoir 103. The light source 104 and light detector 105 are in electrical communication with processor 102. Any optical property measurement, such as but not limited to, turbidity measurements, color measurements, transmission measurements, refraction measurements, photo image, or opacity measurements of the process fluid may be obtained without departing from the spirit of the invention. While the system depicted in FIG. 2 provides an automated, in-line system for measuring the optical property, it is anticipated that one may take manual samples of the process fluid and test for optical properties outside the system without departing from the spirit of the present invention.

Once the initial optical value is measured by detector 105, processor 102 compares the initial value against the threshold optical value. The processor can determine, for example, the difference between the initial value and the threshold value or, the variation between the initial value and the threshold value. Processor 102 may then use this difference and/or variation to determine what modification may need to be made to the process fluid to provide a reconstituted fluid. In some preferred embodiments the modification is the addition of a chemical and the processor 102 uses the difference and/or variation to determine what quantity, if any, of chemical stored in chemical reservoir 106, should be added to the process fluid. Preferably, the chemical to be added to the process fluid is an oxidizing agent such as ozone or hydrogen peroxide or other chemicals such as HCl, HNO₃, fresh acid, or acetic acid. Processor 102 can also control, for example, the reaction time or temperature at which to reconstitute the process fluid.

If additional chemical is added to the process fluid reservoir 103, one or more subsequent optical values associated with the reconstituted fluid are then measured. Processor 102 compares these subsequent optical values against the threshold value. If the subsequent optical value or values of the reconstituted process fluid are not substantially equal, fall outside the range for the threshold value, and/or are too great, the process fluid may be discarded down drain 107. A fresh batch or process fluid may then be prepared for further processing.

Once the process fluid meets the threshold optical property value, the process fluid may be exposed to the electronic components within the processing chamber. After the process fluid is exposed to the electronic components, the process fluid is removed from the chamber and returned to the process fluid reservoir 103. The removal of one process fluid with another process fluid in the enclosable single processing chamber can be accomplished in several ways. For example, the process fluid in the process processing chamber can be substantially completely removed (i.e., drained), and then the next process fluid can be directed into the processing chamber during or after draining. In another embodiment, the process fluid present in the processing chamber can be directly displaced by the next desired process fluid as described for example in U.S. Pat. No. 4,778,532.

The optional reactive chemical process fluids useful in the present invention contain one or more chemically reactive agents to achieve the desired surface treatment. Preferably, the concentration of such chemically reactive agents will be greater than 1000 ppb and more preferably greater than 10,000 ppm, based on the weight of the reactive chemical process fluid. However, in the case of ozone, generally the concentration is equal to or greater than about 10 ppm, more preferably from about 10 ppm to about 50 ppm. Examples of chemically reactive agents include for example hydrochloric acid or buffers containing the same, ammonium hydroxide or buffers containing the same, hydrogen peroxide, sulfuric acid or buffers containing the same, mixtures of sulfuric acid and ozone, hydrofluoric acid or buffers containing the same, chromic acid or buffers containing the same, phosphoric acid or buffers containing the same, acetic acid or buffers containing the same, nitric acid or buffers containing the same, ammonium fluoride buffered hydrofluoric acid, deionized water and ozone, or combinations thereof.

It is also possible for the reactive chemical process fluid to contain 100% of one or more chemically reactive agents. For example, it may be desired to contact the electronic components with solvents such as acetone, N-methyl pyrrolidone, or combinations thereof. Such solvents are chemically reactive agents used, for example, to remove organics or to provide other cleaning benefits.

Examples of preferred reactive chemical process fluids useful in the present invention include cleaning fluids, etching fluids, and photoresist removal fluids. Cleaning fluids typically contain one or more corrosive agent such as an acid or base. Suitable acids for cleaning include for example sulfuric acid, hydrochloric acid, nitric acid, or aqua regia. Suitable bases include for example, ammonium hydroxide. The desired concentration of the corrosive agent in the cleaning fluid will depend upon the particular corrosive agent chosen and the desired amount of cleaning. These corrosive agents may also be used with oxidizing agents such as ozone or hydrogen peroxide. Preferred cleaning solutions are “APM” solutions containing water, ammonia, and hydrogen peroxide, and “HPM” solutions containing water, hydrogen peroxide, and hydrochloric acid. Typical concentrations for APM solutions range from about 5:1:1 to about 200:1:1 parts by volume H₂O:H₂O₂:NH₄OH. Typical concentrations for HPM solutions range from about 5:1:1 to about 1000:0:1 parts by volume H₂O:NH₄:HCl.

Suitable etching solutions contain agents that are capable of removing oxides. A common etching agent used is for example hydrofluoric acid, buffered hydrofluoric acid, ammonium fluoride, or other substances which generate hydrofluoric acid in solution. A hydrofluoric acid containing etching solution may contain for example from about 4:1 to about 1000:1 parts by weight H₂O:HF. One skilled in the art will recognize that there are various process fluids that can be used during wet processing. Other examples of process fluids that can be used during wet processing are disclosed in “Chemical Etching” by Werner Kern et al., in Thin Film Processes, edited by John L. Vossen et al., published by Academic Press, NY 1978, pages 401-496, which is incorporated by reference in its entirety.

For example, in one embodiment of the present invention, the electronic components are contacted with a cleaning solution such as an APM solution, an HPM solution, and/or a hydrofluoric acid solution. The APM solution, the HPM solution, and the etching solution may be used in any sequence. In preferred embodiments, the electronic components are contacted with an APM solution having a concentration of about 80:3:1 parts by volume H₂O: H₂O₂: NH₄OH; an HPM solution having a concentration of 80:1:1 parts by volume H₂O:NH₄:HCl; and/or a hydrofluoric acid solution having a concentration of about 4:1 to about 1000:1 parts by volume H₂O:HF. Preferably, the APM, HPM, and/or hydrofluoric acid solutions are at a temperature of from about 15° C. to about 95° C., and more preferably from about 25° C. to about 45° C. Preferably, the rinsing liquid is at a temperature of from about 15° C. to about 90° C., and more preferably from about 25° C. to about 30° C. The use of an HPM, APM, and/or hydrofluoric acid solution is particularly useful for cleaning and etching. Following contact with the APM, HPM, and/or hydrofluoric acid solution, the electronic components may be optionally rinsed with a rinsing liquid such as deionized water. By applying the methods of the present invention, the rinse time may be reduced or eliminated.

In another embodiment of the present invention, the electronic components may be contacted with an etching solution. Where the etching solution contains hydrofluoric acid, preferably the temperature of the hydrofluoric acid is from about 15° C. to about 95° C., and more preferably from about 24° C. to about 40° C. Following etching, the electronic components may be contacted with a rinsing liquid such as deionized water. Preferably the temperature of the rinsing liquid is from about 15° C. to 90° C., and more preferably from about 25° C. to about 30° C.

The electronic components may also be contacted with rinsing fluids during the methods of the present invention. Any rinsing fluid may be chosen that is capable of achieving the effects described above. It is anticipated, however, the time and temperature of these rinse cycles as well as the number of rinse cycles may be reduced by controlling the optical quality of the process fluids. In selecting a rinsing fluid, such factors as the nature of the surfaces of the electronic components to be rinsed, the nature of contaminants dissolved in the reactive chemical process fluid, and the nature of the reactive chemical process fluid to be rinsed should be considered. Also, the proposed rinsing fluid should be compatible (i.e., relatively non-reactive) with the materials of construction in contact with the fluid. Rinsing fluids which may be used include for example water, organic solvents, mixtures of organic solvents, ozonated water, or combinations thereof. Preferred organic solvents include those organic compounds useful as drying solutions disclosed hereinafter such as C₁ to C₁₀ alcohols, and preferably C₁ to C₆ alcohols. Preferably the rinsing fluid is a liquid and, more preferably, deionized water.

Rinsing fluids may also optionally contain low levels of chemically reactive agents to enhance rinsing. For example, the rinsing fluid may be a dilute aqueous solution of hydrochloric acid or acetic acid to prevent, for example, metallic deposition on the surface of the electronic component. Surfactants, anti-corrosion agents, and/or ozone are other additives used in rinsing fluids. The concentration of such additives in the rinsing fluid is minute. For example, the concentration is preferably not greater than about 1000 ppm by weight and more preferably not greater than 100 ppm by weight based on the total weight of the rinsing fluid. In the case of ozone, preferably the concentration of ozone in the rinsing fluid is 5 ppm or less.

One skilled in the art will recognize that the selection of reactive chemical process fluids, the sequence of reactive chemical process fluids and rinsing fluids, and the processing conditions (e.g., temperature, concentration, contact time and flow of the process fluid) will depend upon the desired wet processing results. For example, the electronic components could be contacted with a rinsing fluid before or after one or more chemical treatment steps. Alternatively, it may be desired in some wet processing methods to have one chemical treatment step directly follow another chemical treatment step, without contacting the electronic components with a rinsing fluid between two chemical treatment steps (i.e., no intervening rinse). Such sequential wet processing, with no intervening rinse, is described in for example U.S. Pat. No. 6,132,522, which is hereby incorporated by reference in its entirety.

Following wet processing with the process fluid, reactive chemical process fluids or rinsing fluids, the electronic components are preferably dried. By “dry” or “drying” it is meant that the electronic components are preferably made substantially free of liquid droplets. By removing liquid droplets during drying, impurities present in the liquid droplets do not remain on the surfaces of the semiconductor substrates when the liquid droplets evaporate. Such impurities undesirably leave marks (e.g., watermarks) or other residues on the surfaces of the semiconductor substrates. However, it is also contemplated that drying may simply involve removing a treating, or rinsing fluid, for example with the aid of a drying fluid stream, or by other means known to those skilled in the art. Any method or system of drying may be used. Suitable methods of drying include for example evaporation, centrifugal force in a spin-rinser-dryer, steam or chemical drying, or combinations thereof. In a preferred embodiment, the wet processing and drying is performed in a single processing chamber without removing the electronic components from the processing chamber. Suitable drying methods also include methods that leave a thin film, or portion thereof, on the surfaces of the electronic components.

A preferred method of drying uses a drying fluid stream to directly displace the last processing solution that the electronic components are contacted with prior to drying (hereinafter referred to as “direct displace drying”). Suitable methods and systems for direct displace drying are disclosed in for example U.S. Pat. Nos. 4,778,532, 4,795,497,4,911,761,4,984,597,5,571,337, and 5,569,330. Other direct displace dryers that can be used include Marangoni type dryers supplied by manufacturers such as Mattson Technology, Inc. Preferably, the drying fluid stream is formed from a partially or completely vaporized drying solution. The drying fluid stream may be for example superheated, a mixture of vapor and liquid, saturated vapor or a mixture of vapor and a noncondensible gas.

The drying solution chosen to form the drying fluid stream is preferably miscible with the last process fluid in the process chamber and non-reactive with the surfaces of the electronic components. The drying solution also preferably has a relatively low boiling point to facilitate drying. Since water is the most convenient and commonly used solvent for chemical treatment or rinsing fluids, a drying solution which forms a minimum-boiling azeotrope with water is especially preferred. For example, the drying solution is preferably selected from organic compounds having a boiling point of less than about 140° C. at atmospheric pressure. Examples of drying solutions which may be employed are steam, alcohols such as methanol, ethanol, 1-propanol, isopropanol, n-butanol, secbutanol, tertbutanol, or tert-amyl alcohol, acetone, acetonitrile, hexafluoroacetone, nitromethane, acetic acid, propionic acid, ethylene glycol mono-methyl ether, difluoroethane, ethyl acetate, isopropyl acetate, 1,1,2-trichloro-1,2,2-trifluoroethane, 1,2-dichloroethane, trichloroethane, perfluoro-2-butyltetrahydrofuran, perfluoro-1,4-dimethylcyclohexane or combinations thereof. Preferably, the drying solution is a C₁ to C₆ alcohol, such as for example methanol, ethanol, 1-propanol, isopropanol, n-butanol, secbutanol, tertbutanol, tert-amyl alcohol, pentanol, hexanol or combinations thereof.

Following drying, the electronic components may be removed from the drying processing chamber and further processed in any desired manner.

Those skilled in the art will appreciate that numerous changes and modifications may be made to the preferred embodiments of the invention and that such changes and modifications may be made without departing from the spirit of the invention. It is therefore intended that the appended claims cover all equivalent variations as fall within the true scope and spirit of the invention.

What is claimed is:

1. A method of processing an electronic component, comprising:
a. measuring an initial value of an optical property associated with a process fluid;
b. exposing a batch of one or more electronic components to the process fluid;
c. measuring the subsequent values of optical property associated with the process fluid in periodic intervals;
d. comparing the initial value of the optical property with the subsequent values of the optical property; and
e. modifying the process fluid to restore the process fluid to the initial optical property value.

2. The method of claim 1 wherein the modifying step comprises determining the quantity of a chemical to restore the process fluid to the initial optical property value.

3. The method of claim 2 further comprising the step of adding the chemical to the process fluid to provide a reconstituted process fluid.

4. The method of claim 3 wherein the chemical is selected from the group consisting of: sulfuric acid; sulfuric acid mixtures; hydrochloric acid; buffered hydrofluoric acid mixtures; dilute hydrofluoric acid mixtures; ozone; deionized water; phosphoric acid; phosphoric acid mixtures; nitric acid; acetic acid; hydrogen peroxide; ammonia; chromic acid; and mixtures thereof.

5. The method of claim 3 wherein the chemical is selected from the group consisting of: C₁ to C₁₀ alcohols; deionized water; ozone; and mixtures thereof.

6. The method of claim 1 wherein the comparison is used to control the reaction time and temperature of the chemical within the process fluid.

7. The method of claim 1 wherein the comparison of the optical property values is performed by a processor.

8. The method of claim 7 wherein the optical property is selected from the group consisting of: turbidity measurements, color measurements; transmission measurements; refraction measurements; photo image; and opacity measurements.

9. The method of claim 8 wherein the optical property is selected from the group consisting of: transmission measurements and refraction measurements.

10. A method of processing an electronic component with a processing fluid comprising:
a. measuring a first value of an optical property associated with the process fluid;
b. comparing the first value of an optical property with a threshold value
of an optical property to obtain a variation value;
c. modifying the process fluid based on the variation value; and
d. repeating steps (b) and (c) until the threshold value is obtained; and
e. discarding the process fluid when the variation value is outside an acceptable range.

11. The method of claim 10 wherein the processing fluid is selected from the group consisting of: sulfuric acid; sulfuric acid mixtures; hydrochloric acid; buffered hydrofluoric acid mixtures; dilute hydrofluoric acid mixtures; ozone; deionized water; phosphoric acid; phosphoric acid mixtures; nitric acid; acetic acid; hydrogen peroxide; ammonia; chromic acid; and mixtures thereof.

12. The method of claim 10 wherein the process fluid is selected from the group consisting of: C₁ to C₁₀ alcohols; deionized water; ozone; and mixtures thereof.

13. The method of claim 10 wherein the optical property is selected from the group consisting of: turbidity measurements, color measurements; transmission measurements; refraction measurements; photo image; and opacity measurements.

14. The method of claim 13 wherein the optical property is selected from the group consisting of: transmission measurements and refraction measurements.

15. A method of controlling haze growth on a semiconductor wafer during wet processing with a sulfuric acid process fluid in a single processing chamber system comprising:
a. measuring a first value of a transmission associated with the process fluid;
b. comparing the first value of a transmission with a threshold value of a transmission to obtain a variation value;
c. modifying the sulfuric acid process fluid based on the variation value; and
d. repeating steps (b) and (c) until the threshold value is obtained; and
e. discarding the sulfuric acid process fluid when the variation value is outside an acceptable range.

16. A system for treating an electrical component, comprising:
a process chamber containing one or more electrical components;
a process fluid reservoir that is in fluid communication with the process vessel;
an optical measurement system that measures one or more optical property values of a process fluid contained within the process fluid reservoir;
a chemical reservoir that is in fluid communication with the process fluid reservoir; and
a processor that is in electrical communication with the optical measurement system and the chemical reservoir wherein the processor compares the values of the optical property with a threshold value and determines a quantity of chemical from the chemical reservoir that needs to be added to the process fluid reservoir to restore the value of optical property associated with the process fluid to the threshold value.

17. The system of claim 16 wherein the processor controls the reaction time and temperature of the chemical within the process fluid.

18. The system of claim 16 wherein the process fluid reservoir further comprises a window through which the optical measurement system measures the one or more optical properties.

19. The system of claim 16 further comprising a drain for discarding the process fluid that fails to meet the threshold value.

20. The system of claim 16 wherein the one or more optical property values is selected from the group consisting of: turbidity measurements, color measurements; transmission measurements; refraction measurements; photo image; and opacity measurements.
